(19) United States
(12) Patent Application Publication
(10) Pub. No.: US 2010/0309481 A1
(43) Pub. Date: Dec. 9, 2010

(54) Uncertainty of uncertainty

(76) Inventor: James D. Welch, Omaha, NE (US)

Correspondence Address: JAMES D. WELCH, 10328 PINEHURST AVE., OMAHA, NE, 68124, US

(21) Appl. No.: 12/806,521

(22) Filed: Aug. 16, 2010

Related U.S. Application Data
(63) Continuation-in-part of application No. 12/387,450, filed on May 4, 2009.
(60) Provisional application No. 61/211,514, filed on Mar. 31, 2009.
(60) Provisional application No. 61/397,156, filed on Jun. 9, 2010.
(60) Provisional application No. 61/399,165, filed on Jul. 8, 2010.

(51) Int. Cl. G01B 9/02; G01N 23/00

(52) U.S. Cl. 356/521; 250/473.1

(57) ABSTRACT

An approach to challenging the absolute nature attributed to the Heisenberg uncertainty principal in the context of data obtained from a double slit system, wherein the double slit system is applied at least once with a multiplicity of photons or particles to produce a reference interference pattern on a first screen, and applied a second time to determine where a single photon or particle impacts a second screen. Comparison of projections from each slit through the point of impact of the single photon or particle on the second screen, to the reference interference pattern on the first screen, provides insight to which slit the single photon or particle passed.

This Application is a CIP of Pending application Ser. No. 12/387,450 Filed May 4, 2009, and therevia Claims Benefit of 61/211,514 Filed Mar. 31, 2009. This Application also directly Claims benefit of 61/397,156 Filed Jun. 9, 2010 and 61/399,165 Filed Jul. 8, 2010.

### TECHNICAL FIELD

The present invention relates to the problem of determining through which slit of a double slit system a particle or photon passes when forming an interference pattern on a screen beyond said slits. More specifically the present invention is a method of applying said double slit system to the end that both knowledge of an interference pattern formed on a screen, and improved probability of knowing through which slit a particular particle or photon passed in the act of forming said interference pattern is achieved, said method involving use of an interference pattern formed on another screen located at a different distance from the double slits, as a reference.

### BACKGROUND

To begin, it is noted that the situation as to how a photon or particle moves between the slits of a double slit system and a screen upon which they impact, is perhaps similar to that in relativity which provides that mass and energy tell space-time how to warp, and space-time tells mass and energy how to move. That is, it might be that a moving photon or particle creates a wave that interferes with itself after passing through the double slits, and that interference condition tells the moving photon or particle how to move at each point in its trajectory. If this is the case, in light of Einstein's tensor approach to sorting out the mass, energy, space-time interaction, the same approach might be beneficially applied to mathematically sort out what is going on between the slits and screen in a double slit system. It might be that, however, as disclosed herein, the situation might be simpler in the double slit scenario.

Continuing, ever since passing a Maple requiring mathematics intensive course in Quantum Mechanics a decade+ ago:
(then stepping back and wondering - - - “what the hell was that?” - - - and then sitting through two advanced quantum courses in which I became “boggled by Bell”, and then later listening to Prof. Feynman's California and New Zealand lectures years ago, in which he said that no-one then knew how to determine which Slit of a Double Slit system a Particle or Photon passes while still securing an Interference Pattern (IP) - - - but maybe someday someone will figure it out) - - -
   I've been pondering the situation. This has led to various ideas being submitted to the USPTO to secure publication of my ideas. For instance, put the Double Slit system in a Bubble or Cloud Chamber or the like, and watch ions travel therethrough, or use particles which emit electromagnetic radiation, or detect particles which reflect from the Screen on which they form an Interference Pattern, (see Published Application US 2005/0168748). So far however, my proposals have been responded to as being, at best, extremely difficult to actually practice so that results would be suspect. A common objection has been that monitoring the photon or particle in any way what-so-ever affects the momentum thereof, which in turn adversely affects the formation of the Interference Pattern. However, guided by something I learned from my decades long study of Scientology - - - that being that in this universe there are no absolutes - - - I am proceeding in this because I believe that observation includes the Uncertainty Principal. That is I, as did Einstein, believe that the Uncertainty Principal can not be an absolute in this Universe!

Recently, while watching a video on Quantum Mechanics and on Impossibility produced by the Teaching Co., I could not help but recall how Prof. Feynman beneficially used a “renormalization” procedure in developing Quantum Electrodynamics (QED). That has led to my conceiving a “back door” approach to the Double Slit problem. That is, knowledge of which Slit a particle or photon passes might be improved by a measurement - - - after - - - it contributes to formation of an Interference Pattern. This does not allow simultaneously forming an Interference Pattern and knowing through which Slit a particle or photon passed at the same instant in time, (but then no approach could do that as it takes time for a particle that passes through a Slit to reach a Screen), but rather allows improving the probability of knowing, later in time, which Slit the particle or photon passed after it contributed to the formation of the Interference Pattern. In that regard it is unclear as to if defeats the Uncertainty Principal, as it does not involve simultaneous measurement of momentum and location, but what is presented might provide a way to obtain more certain information thought to be unavailable, as a matter of physical laws. It might be that a principal is hereby illuminated, which teaches that one, when limited by Quantum Mechanics as to what can be known, should look to what can be known, (eg. the pattern of an Interference patent can be calculated from known equations), and use that knowledge to work backwards and obtain what can't be directly measured.

Continuing, better insight to the problem is realized by noting that it is known that when a beam of photons is caused to flow from a source located to one side of a barrier which has two closely situated slits therein, then an interference pattern can form and be observed on a screen at some distance beyond said barrier. This is true unless one attempts to directly determine which slit a photon passes through. If one attempts to monitor which slit a photon passes through, it is always found that the interference pattern is altered to an extent directly related to success attained in determining through which slit a specific photon passed. That is, any attempt to determine which slit a photon passes through prevents the formation interference pattern. The same situation is observed when the flow of photons is replaced with a flow of electrons or other particles. In summary of this concept it is noted that it is generally agreed that it is impossible to determine both momentum and position of a particle, under Heisenberg's Uncertainty Principal. This has to do with the Wave functions for position and momentum having different Basis Functions in Quantum Mechanics and where one of the Wavefunctions collapses to a specific allowed value, the other consists of a multiplicity of possibilities. In the context of a Double Slit system, this translates to saying that since it is possible to accurately determine the momentum of a photon or particle approaching a Double Slit arrangement, it is impossible to know its exact position. Alternatively, it is possible to measure the lateral momentum of a photon or electron that passed through a Slit by monitoring where the photon or particle impinges on a Screen on which an Interference Pattern forms, hence any success in monitoring through which Slit (ie. position), it passes then becomes impossible. This means that the best probability known about which Slit a photon or particle passes is known only on a 50/50 basis. That is, it is generally accepted that when an Interference Pattern is formed, the best one can say is that the photon or particle might have gone through one Slit or it might have gone through the other.

It is also recited that for moving particles, the DeBroglie wavelength thereof is given by dividing Plank's Constant by momentum:

Wavelength=h/p;

where h is Plank's Constant 6.626×10⁻³⁴ J-sec, and “p” is momentum. Also for reference, the rest mass of an electron is 9.11×10−31 Kg, and the mass of a Proton is about 1800 times as large. Further for a Double Slit arrangement, the Interference Pattern is characterized by:

H×Sin(θ)=#×wavelength; and

as Sin(θ) is approximately Z/X, the position “Z” on a Screen where a photon or particle impinges after passing through Double Slits which are Spaced apart by “H”, and at which is present a peak intensity, is approximately:

$$Z = \frac{\# \times Wavelength \times X}{H} ;$$

where “X” is the distance of the Screen from said Double Slits, and where “Z” is the distance from the perpendicular intersection of the Screen by a line taken from the mid-point between the Double Slits which is perpendicular to the Plane of said Double Slits, and # is an Integer.

It is also noted that to cause a charged particle to move toward and through Double Slits, an Electric Field is generally applied. That is the basis for discharging a single charged particle toward a double slit system.

To give some insight to realistic numbers, for a Slit Spacing of 10⁻⁷ M, an Interference Pattern of about 10⁻⁴ M in Width is formed at a Screen located a distance (“X” or “Y” in FIGS. 1 and 2) of 2×10⁻² M away. This means h/mv=5×10⁻¹⁰. So, Velocity=(6.626×10⁻³⁴ J-sec)/((9.11×10⁻³¹ Kg)*(5×10⁻¹⁰)=1.37×10⁹ meters/sec. If the Slit Spacing is increased to 10⁻⁵ M this reduces to 1.37×10⁷ meters/sec. And if a Proton is used which has a Mass of about 1.8×10³ that of the Electron, the velocity drops to 7.61×10³ Meters/sec.

In conclusion of this Section of this Specification it is stated that the present invention provides an approach to arriving at better than a 50/50 probability of knowing through which Slit of a Double Slit System a photon or particle, which contributes to formation of an Interference Pattern, passed.

### DISCLOSURE OF THE INVENTION

The present invention is a method of applying a double slit system to the end of securing improved knowledge of both a formed interference pattern, and through which silt thereof a particle or photon passes in the act of forming said interference pattern. Said method comprises:

a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
   said system being arranged to allow said source to project a particle or photon at said barrier having two slits therein, pass through a slit and contribute to formation of an interference pattern at the first screen.

Said method further comprises:

b) with only the first screen in place at a distance (X) from the double slits, causing a multiplicity of particles or photons from said source thereof to pass through one or the other of the slits in said barrier having two slits therein and develop an interference pattern at the location of the first screen, and securing said pattern;

c) causing said second screen to be located at a distance (Y) from said barrier having two slits therein, wherein (Y) is less than (X);

d) causing a particle or photon to pass through one or the other of said slits in said barrier having two slits therein, and impinge on said second screen;

e) noting the location where upon said second screen said particle in step d impinges, and projecting lines from each slit through said location on said second screen and determining where said lines impinge on the fixed the interference pattern developed in step b; and

concluding that the projection line consistent with the greatest probability corresponding to said interference pattern on the first screen indicates through which slit the particle or photon passed to a better than 50/50 certainty. It is noted that this is better than what the Uncertainty Principal teaches can be possible. The Uncertainty Principal holds that if one measures where on the second screen the photon or particle impinges, it is impossible to know which slit it went through.

Said method can further comprise, while improving the probability of which slit through which a particle or photon passes as in step e, causing a sequential multiplicity of particles to impinge on said second screen, one by one by repeating steps c-e, to the end that an interference pattern is achieved upon said second screen.

Said method can involve the distance (X) at which the first screen is located is selected by determining the minimum distance from said double slits consistent with formation of an interference pattern, then moving it a distance dx further away and practicing step b; and where the distance (Y) at which the second screen is placed is said minimum distance from said double slits consistent with formation of an interference pattern before practicing steps c-e. This configuration minimizes any nonlinearity of trajectory associated with photon or particle movement between the slits, and the first and second screens.

Said method can involve that the particle or photon location on the second screen is on a locus of a line between a bisector of the line distance between the two slits to the middle peak of the interference pattern on the first screen, and wherein it is determined that if the photon or particle intercepts said interference pattern on the first screen to the left of said locus of a line between a bisector of the line distance between the two slits to the peak of the interference pattern on the first screen then the photon or particle passed through the slit to the right thereof, and if the photon or particle intercepts said interference pattern on the first screen to the right of said locus of a line between a bisector of the line distance between the two slits to the peak of the interference pattern on the first screen then the photon or particle passed through the slit to the left thereof. The problem with this is that ideally there is no difference in probability between the right and left side projections, hence there is no basis for selecting one slit over the over.

While not preferred, a modified method of applying a double slit system to the end of securing knowledge of both an interference pattern, and through which silt thereof a particle or photon passes in the act of forming said interference pattern, comprises:

a) providing a double slit system comprising:
a source of particles or photons capable of providing a single particle or photon at a time;
a barrier having two slits therein;
a second screen located at some distance (Y) from said barrier having two slits therein;
a first screen which can be located at a distance (X) from said barrier having two slits therein, wherein (X) is greater than (Y);
   said system being arranged to allow said source to project a particle or photon at said barrier having two slits therein, pass through a slit and contribute to formation of an interference pattern at the second screen.

Said method further comprises:

b) with the second screen in place at a distance (Y) from the double slits, causing a multiplicity of particles or photons from said source thereof to pass through one or the other of the slits in said barrier having two slits therein, and develop an interference pattern at the location of the second screen, and securing said pattern;

c) removing said second screen from said position (Y), and causing said first screen to be located at a distance (X) from said barrier having two slits therein, wherein (X) is greater than (Y);

d) causing a particle or photon to pass through one or the other of said slits in said barrier having two slits therein, and impinge on said first screen;

e) noting the location where upon said first screen said particle in step d impinges, and projecting lines from each slit through said location on said first screen and determining where said lines impinge on the fixed the interference pattern developed in step b; and

concluding that the projection line consistent with the greatest probability corresponding to said interference pattern on the second screen indicates through which slit the particle or photon passed to a better than 50/50 certainty. It is again noted that this is better than what the Uncertainty Principal teaches can be possible. The Uncertainty Principal holds that if one measures where on the first screen the photon or particle impinges, it is impossible to know which slit it went through.

Again, the method can include, while improving the probability of knowing through which slit through which a particle or photon passes, causing a sequential multiplicity of particles to impinge on said first screen, one by one by repeating steps c-e, to the end that an interference pattern is achieved upon said first screen.

Also, the distance (Y) at which the second screen is located can be selected by determining the minimum distance from said double slits consistent with formation of an interference pattern practicing step b; and wherein the distance (X) at which the first screen is placed is a distance dx from the location of said second screen while practicing steps c-e. This approach minimizes any nonlinearity of trajectory associated with photon or particle movement between the slits, and the first and second screens.

A variation of the method of applying a double slit system to the end of securing improved knowledge of both an interference pattern, and through which silt thereof a particle or photon passes in the act of forming said interference pattern, comprising the steps of:

a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
a third screen located at a distance (X′) from said barrier having two slits therein, wherein (X′) is less than (Y);
   said system being arranged to allow said source to project a particle or photon at said barrier having two slits therein, pass through a slit and contribute to formation of an interference pattern at the first screen.
   The method continues with:

b1) with only the first screen in place at a distance (X) from the double slits, causing a multiplicity of particles or photons from said source thereof to pass through one or the other of the slits in said barrier having two slits therein, and develop an interference pattern at the location of the first screen, and securing said pattern;

b2) with only the third screen in place at a distance (X′) from the double slits, causing a multiplicity of particles or photons from said source thereof to pass through one or the other of the slits in said barrier having two slits therein, and develop an interference pattern at the location of the third screen, and securing said pattern.

The method further continues with:

c) causing said second screen to be located at a distance (Y) from said barrier having two slits therein, wherein (Y) is less than (X) but greater than (X′);

d) causing a particle or photon to pass through one or the other of said slits in said barrier having two slits therein, and impinge on said second screen;

e) noting the location where upon said second screen said particle in step d impinges, and projecting lines from each slit through said location on said second and third screens and determining where said lines impinge on the fixed the interference pattern developed in steps b1 and b2; and

concluding that the projection line consistent with the greatest probability corresponding to said interference pattern on the first and third screen indicates through which slit the particle or photon passed to a better than 50/50 certainty.

The distance (X′) at which the third screen is located can be selected by determining the minimum distance from said double slits consistent with formation of an interference pattern practicing step b2; and the distance (X) at which the first screen is place can be a distance 2dx from said third screen location when practicing step b1, and the distance (Y) can be inbetween said first and third screen locations, a distance dx from each thereof, when practicing steps c-e. This approach minimizes any nonlinearity of trajectory associated with photon or particle movement between the slits, and the first and second screens. It is to be understood that only the mathematical patterns formed in steps b1 and b2 on the third and first screens, respectively, are secured in position. Only the second screen is physically present when steps c-e are practiced.

It is note that the Interference Pattern identified above corresponds to an Intensity and that squaring and normalizing it provides an indication of probability.

It is noted that, while not limiting, the photons or particles can be selected from the group consisting of:
photons;
electrons;
positrons;
protons;
neutrons;
atoms
ionized atoms; and
molecules.

It is also noted that steps other than those involving providing the system can be practiced under the control of a computer. That is steps involving:
causing a multiplicity of particles or photons from said source thereof to pass through one or the other of the slits in said barrier having two slits therein,
developing an interference pattern at the location of the first/second screen, and securing information which describes said pattern; and
causing a particle or photon to pass through one or the other of said slits in said barrier having two slits therein, and impinge on said second/first screen and noting the location where upon said second/first screen said particle impinges, and
projecting lines from each slit through said location on said second/first screen and determining which line is consistent with the information fixed regarding the interference pattern developed earlier; and
concluding that the line consistent with the higher probability indicates through which slit the particle or photon passed;
   can be automated and fully controlled by a computer.

Further, as recently suggested to me, “calculation” could be applied as an approach to forming an Interference Pattern in the steps b above. This can work as the effects of interference are well known and can be calculated. However, to compensate any effects in the specific system applied, it might be best to actually develop the Interference Pattern.

The invention can further involve a scaling up of the dimensions of an achieved Interference Patterns to aid with analysis.

It is noted that where it is stated a line is projected “through” a point, it includes the case where the line is only projected “to” said point on the first screen.

It is also noted that the terminology “securing said pattern” includes securing information which defines said pattern, such as in a computer memory.

Finally, it is specifically pointed out that the present method does not require a photon or particle interact with anything other than the Screen on which an Interference Pattern is formed. This avoids the problem of altering the momentum of a photon or particle as part of the method, (eg. monitoring a particle which reflects from a Screen on which is formed an Interference Pattern via a second Screen).

The present invention will be better understood by reference to the Detailed Description Section of this Specification in combination with the Drawings.

### BRIEF DESCRIPTION OF THE DRAWINGS

FIGS. 1 and 2 demonstrate double slit systems applied in the present invention methodology.

FIG. 3 shows how expected “channels” of Interference Pattern location v. distance from silts can be developed experimentally by developing Interference Patterns at a plurality of screen locations.

FIG. 4 shows a special condition wherein the present invention of a photon or particle interaction with a double slit system based on assuming a photon or particle linear trajectory.

FIG. 5. which shows an Application of a double slit system to provide knowing with improved probability which slit a photon or particle passes in a double slit system while still forming an interference pattern.

FIGS. 6a and 6b demonstrate two and three screen double slit systems.

### DETAILED DESCRIPTION

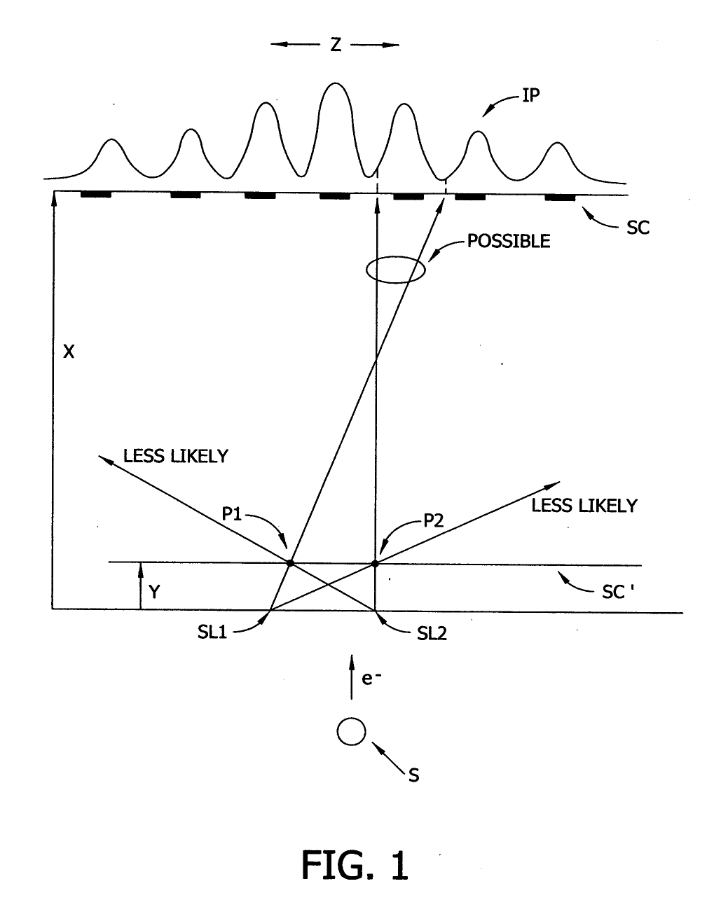

Turning now to FIG. 1, there is shown a well known experimental system of two Slits (SL1) and (SL2), with a Source (S) provided particle electron or photon or molecule etc. (e⁻) approaching. Also shown are two screens (SC) and (SC′) at distances (X) and (Y), (where Y is less than (X)), respectively. Screen (SC) is indicated as having had an Interference Pattern (IP) formed thereupon by causing a multiplicity of particles or photons to impinge thereupon, preferably one at a time, when the Second Screen (SC′) is not present. While it is generally accepted that the particle or photon passed through one of the Slits (SL1) (SL2), it is known that any attempt to monitor which Slit (SL1) (SL2) it passed, causes the Interference Pattern (IP) to disappear. In view of the Uncertainty Principal it is generally believed that it is impossible to know both which slit a particle or photon passed, and still see an Interference Pattern (IP) form.

Now, with the indicated Interference Pattern (IP) secured AND LEFT IN PLACE at the location (X) of Screen (SC), a Second Screen (SC′), (which can be the First Screen moved), is entered which is closer to the Slits (SL1) (S12), but not so close as to block either Silt (SL1) (S12). Then particles or photons are caused to impinge thereupon one at a time, and impinge on the Second Screen (SC′). Now, knowing how the Double Slit system performed, (eg. the left in place formed Interference pattern (IP)), when the First Screen (SC) was placed distance “X” from the Slits (SL1) (SL2), and the positions of said Slits (SL1) (SL2), it is possible to project a line from each Slit (SL1) (SL2) through the point on the Second Screen (SC′) where the particle or photon impinged, and see where it would have impinged on the First Screen (SC) if the Second Screen (SC′) were absent. As FIG. 1 shows, it might be readily obvious that the particle or photon (P1) (P2) must have passed through one of the Slits (SL1) (SL2), as if it passed through the other Slit (SL1) (SL2) it would not have reached the First Screen (SC), at a location consistent with the Interference Pattern (IP) secured when said First Screen (SC), which was (X) away from the from the Slits (SL1) (SL2), when the Second Screen (SC′) absent. But, projections from the Slits (SL1) (SL2) to the First Screen (SC) Interference Pattern (IP) do provide a clear indication that one Slit would provide more probable results. Note it is not necessary that a projection land on the First Screen (SC) at a location corresponding to a peak of the Interference Pattern (IP). In fact, both projections identified as “Possible” associate with relatively low Intensities.

The present approach assumes a particle or photon's path to a Screen (SC) (SC′) is determined as soon as it emerges from one of the Slits (SL1) (SL2). That is, it is assumed that a straight line can be drawn from each of the Slits (SL1) (SL2) through a point of impingement on the Second Screen (SC′) to project where the particle of photon would have arrived at the position (X) away from the Slits (SL1) (SL2), had the Second Screen (SC2) not been present.

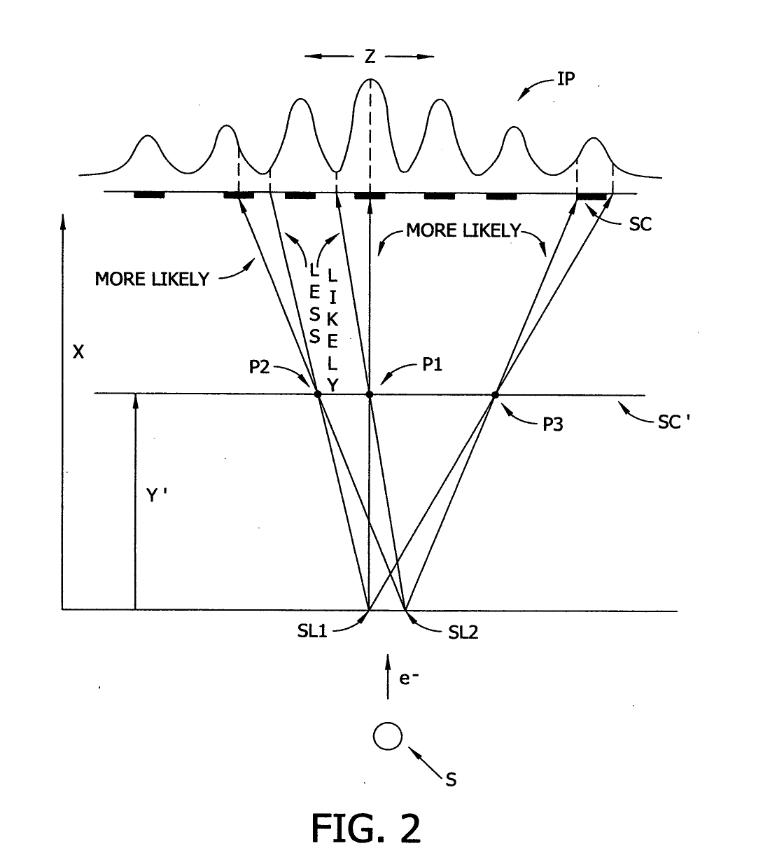

FIG. 2 shows a FIG. 1 scenario with the Slits (SL1) (SL2) situated more closely together and with the Second Screen (SC′) closer to the First Screen (SC) than is the case in FIG. 1. The example of FIG. 2 is less exaggerated, but note that it is still possible that the same present invention methodology will lead to a similar result, that being that a particle or photon impinging on the Second Screen (SC′) will project to a peak region of an Interference Pattern on the First Screen (SC), or a low probability region, depending through which Slit (SL1) (SL2) the particle or photon is assumed to have passed. Note that FIG. 2 demonstrates that a Particle (P1) impinged on the Second Screen (SC′), at a location for which projections from Slits (SL1) and (SL2) therethrough intercept the First Screen (SC), with the projection from the First Slit (SL1) approaching the Interference Pattern at a Peak of the Interference pattern and with the projection from the Second Slit (S12) approaching the Interference Pattern at a Valley of the Interference pattern. The method of the present invention provides that this shows a better than 50/50 probability that the photon or particle that was measured on the Second Screen (SL') at point (P1), passed through the First Slit (SL1). (Note, to correspond to probability the Interference Pattern (IP) on the First Screen (SC) the shown Intensity pattern would have to squared).

It is also disclosed that a probability as to which Slit a photon or particle passes can be developed by a procedure involving determining the intensity associated with how photons or particles impinge at each point on the First Screen (SC) during formation of the Interference Pattern (IP) thereon. Then, perhaps, divide all the intensities by that at the lowest valley such that the lowest valley shows an intensity of 1. Then when the Projections are made from the Slits (SL1) and (SL2) through a point on the Second Screen (SC′) to the First Screen (SC), one can determine what intensity corresponds to the location at which each Projection intersects the First Screen (SC). Say that the highest peak corresponds to an intensity of 100 and one Projection does indeed correspond to the Highest Peak, and the other Projection corresponds to the lowest Valley, one can determine the 100 out of 101 times the First Projection is valid. This is essentially, although not quite, 100%. The Third Particle (P3) in FIG. 2 demonstrates this for much closer intensities. Say the Intensities are associated with a more probable 10 and a less probable 2. The probability that the Slit (SL2) associated with the 10 is the one the photon or particle that impinged on the Second Screen (SC′) through which the projections pass, is 10/(12)=83%, while the probability that it passed through the other Slit (S11) is only 17%. That is much better than 50/50. Even for the case where the projections correspond to intensities of 5 and 4, the probability that the photon or particle passed through the Slit associated with the intensity of 5 is the one the photon or particle that impinged on the Second Screen (SC′) through which the projections pass, is 5/9=55%, which is again better that 50%, which the best possible result before application of the present invention. The benefits provided by the present invention will vary with each photon or particle, depending on where it arrives at the Second Screen (SC′), but in all cases where said projections lead to determining different intensities on the First Screen (SC) Interference Pattern Curve, it will result that one of the Slits will be shown as the more probable one.

While the present method does not determine 100% confidence as to which Slit a photon or particle passes, it does provide a potentially very high probability that, (in the case of some particles, depending on where projections from the Slits through the location of a photon or particle impingement on the Second Screen, impinge on the Interference Pattern Curve), knowledge of which Slit the photon or particle passed can be determined. This is coupled with 100% measured knowledge of where on the Second Screen the photon or particle impinged. In that light some inroad to overcoming the Uncertainty Principal might be achieved. It can, however, be argued that since some chance remains that the photon or particle did not pass through the Slit associated with the high probability, that an Uncertiainty remains as to which Slit the photon or particle which impinges on the Second Screen passed, thus leaving the Uncertainty Principal intact. As the Uncertainty Principal seems to be deeply ingrained in the fabric of Physics, this is perhaps a good result.

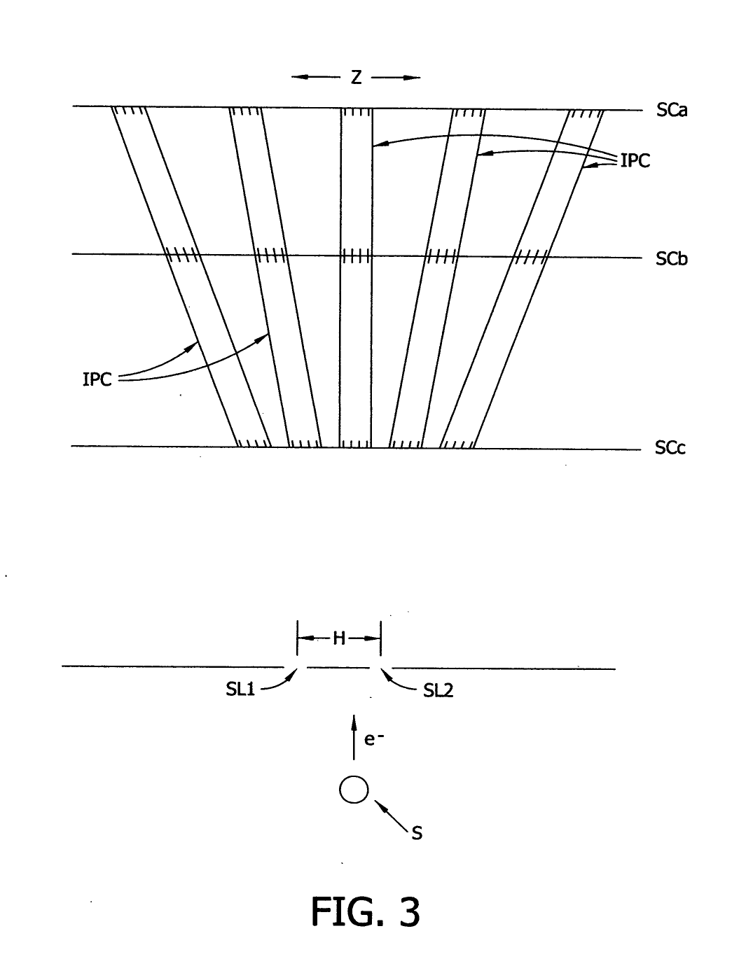

Note, it is the Interference Pattern formed on the Second Screen (SC′), for which improved probability will be known as regards which Slit (SL1) (SL2) each particle or photon passed. The present invention method is based in a believe that presence or absence of the Second Screen (SC′) should have no effect on how what emerges from the two Slits (SL1) (SL2) directs a particle or photon. That is similar to saying that moving the First Screen (SC) closer or further away from the two Slits (SL1) (SL2) has no effect other than to expand or contract the Interference Pattern laterally. However, should there be an effect other than lateral expansion of the Interference Pattern when the First Screen (SC) is moved from a distance (X) away from the Slits (SL1) (S12), closer to the Slits (SL1) (SL2), this can be compensated by obtaining a plurality/multiplicity of experimental Interference Patterns (IP) at a plurality/multiplicity of distances between the distance (X) and the Slits (SL1) (S12). From the results such an effort one can construct channels in three-dimensional space in which a particle or photon can arrive, and these can be used to enable compensation for any effect of the presence of the Second Screen (SC′). Then one can proceed as described above, with the Screen at (Y). FIG. 3 shows how expected “Channels” (IPC) of Interference Pattern location v. distance from Slits (SL1) (SL2) can be developed experimentally by developing Interference Patterns at a plurality of Screen (SCa) (SCb) (SCc) etc. locations. However, in view of the equation:

$$Z = \frac{\# \times Wavelength \times X}{H} ;$$

which was disclosed in the Background Section, it is believed compensation of such an effect will not be necessary. Note that the lateral spread (Z) of an Interference Pattern is directly proportional to “X”, (and inversely proportional to (H)). Adjustment of parameters (X) (Y) (H) and Wavelength will determine the resulting Interference Pattern dimensions on both Screens (SC) and (SC′).

It is further noted that the method can be practiced by obtaining and fixing an Interference Pattern on a Screen, (eg. (SC′)), located a distance (Y) from the Silts (SL1) (SL2), and the proceed much as described above, with the difference being that said Screen (SC′) is then removed and a single particle or photon is then caused to imping on a Screen, (eg. (SC)), which is further away, (eg. (X)), from the Slits (SL21) (SL2), and then project lines from each Slit (SL1) (S12) through said position on said Screen (SC) where said single particle or photon was caused to impinge. It can again occur that the projected line from one Slit passes through the fixed in place Interference Pattern on the Screen (SC′) nearer the Slits (SL1) (SL2) with a higher probability than does the other.

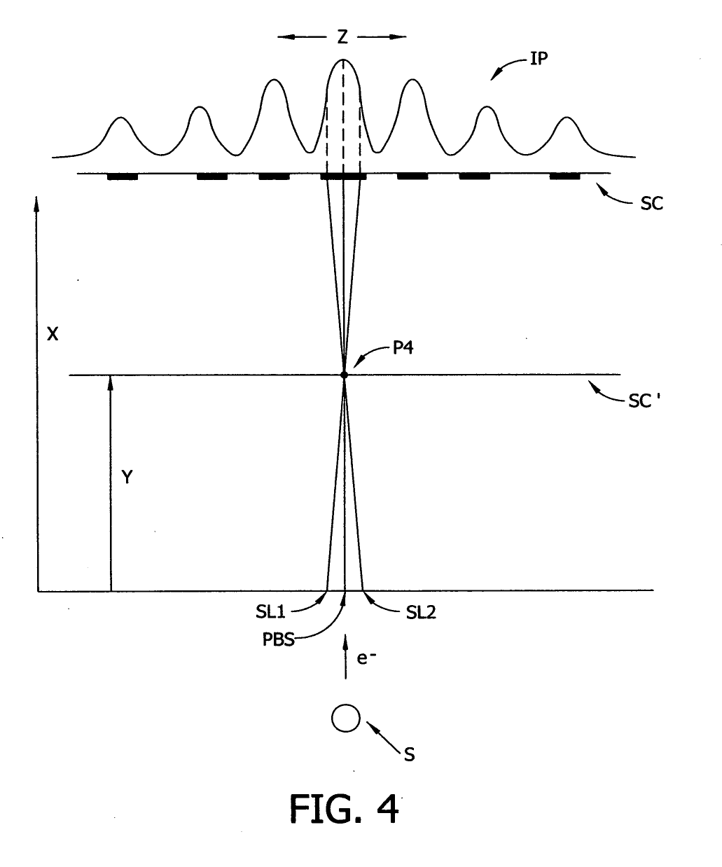

FIG. 4 is included to show that while in foregoing examples, the methodology provides knowledge of an increased probability as to which Slit (SL1) (SL2) a photon or particle passes, where a single photon or particle lands at a central location on Screen (SC′), (ie. along a perpendicular bisector (PBS) midway along a line between the Slits (SL1) (SL2) which projects to, or very near, the Central Peak in the Interference Pattern on Screen (SC), it is not possible to have improved knowledge of which Slit (SL1) (SL2) it passed. Note that where the photon or particle hits Screen (SC′) at point (P4), the projections to the secured Interference Pattern on Screen (SC) indicate it would have encountered said Screen (SC) to the right or left of the peak therein. Unless some externally applied force, or a force generated by the interference pattern between the slits and the screen (SC), changes the photon or particle trajectory in flight, it should be apparent that if the photon or particle hits Screen (SC) to the left of the peak, it had to come from Slit (SL2), and if it hits Screen (SC) to the right of the peak, it had to come from Slit (SL1). To help understanding this, the reader is reminded of the equation provided earlier herein which relates “Z” to “X” via a linear relationship, and in the FIG. 4 scenario, that involves the special case of “#” being set to 1.0. While this provides possible insight based on photon or particle linear trajectories, a problem is that knowing the point (P4) does not lead to an improved probability of knowing which slit (SL1) (SL2) the photon or particle passed, as both projected locations on the Screen (SC) have the same probability associated therewith.

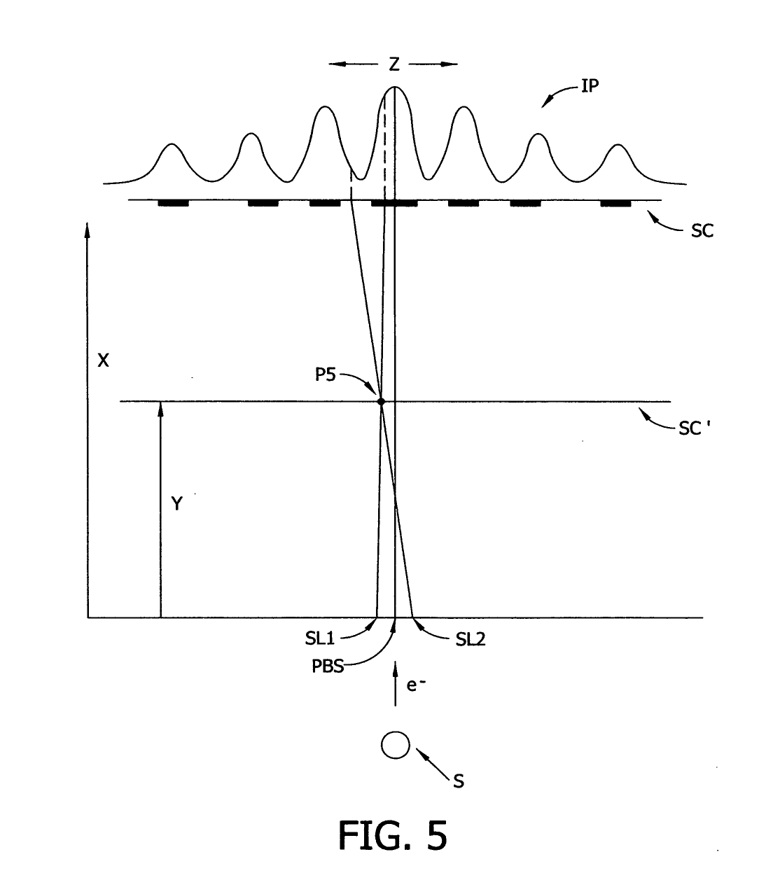

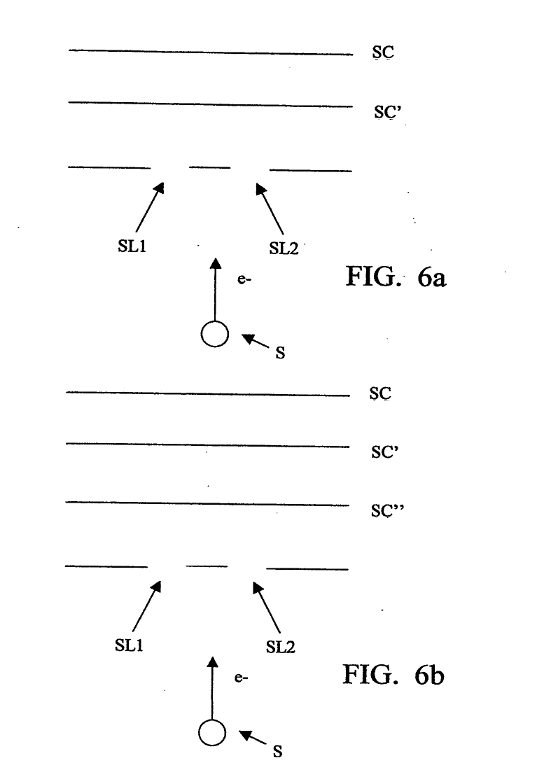

As additional insight this disclosure also proposes a specific experimental approach to investigating the validity of considering the uncertainty principal as absolute, having reference to FIG. 5, which shows another application of a double slit system. As before, suppose an interference pattern (IP) is formed on screen (SC) by a projecting a multiplicity of photons or particles thereat from source (S), and that the formed interference pattern is fixed in place. Next, consider that a second screen (SC) is placed closer to the slits (SL1) (SL2) and a single photon or particle, of the same type used to form the interference pattern on screen (SC), is fired toward the slits (SL1) (SL2) and impinges on screen (SC) at a point identified as (P5), which it is assumed is offset from a bisector of the slits (SL1) (SL2) which projects to the middle of the peak on screen SC). Now, if lines are projected from each slit (SL1) (SL2) through the point (P5) on screen (SC), it is to be noted that they intersect the interference pattern on screen (SC) at different locations thereon. It will be noted that one of the projections is more likely as it intersects the interference pattern on screen (SC) at a more intense location. As additional disclosure, this difference in likelihood is dependent on assuming the particle that impinges at point (P5) on screen (SC′) travels in a straight line from the slit (SL1) (SL2) through which it passed. To minimize adverse affects wherein said “linearity” of photon or particle locus does not apply, the experimental system can be considered configured such that screen (SC′) is placed very close to both screen (SC), and to the slits (SL1) (SL2). That is the distance (X−Y)=dx, and the length Y=dx. In FIG. 6a these distances are seen to be the distances between screens (SC) and (SC′) and between screen (SC′) and the locations of the slits (SL1) (SL2), respectively. This, of course, will decrease the difference between where the line projections from each of the slits (SL1) (SL2) through point (P5) on screen (SC′) intersect the interference pattern on screen (SC), but the point is that the intersection points will be different. Integration based on the liner relationship between screen distance (X) from the slits and the width (Z) of the resulting interference pattern can be applied to approximate photon or particle trajectories. It is also forwarded that use of heavy particles, (eg. Bucky balls), in the experimental procedure might reduce a tendency toward non-linear trajectories. The momentum of a heavy particle exiting a slit (SL1) (SL2) would be less susceptible to influence by interaction between the interference wave condition between the slits (SL1) (SL2) and a screen (SC) (SC′). With reference to FIG. 5, it is noted that a promising experimental approach would involve determining a minimum distance from the location of slits (SL1) (SL2) at which screen (SC) can be placed consistent with formation of an interference pattern (IP) thereon, and then move it dx further away. Screen (SC′) would then be placed dx closer, which is at the minimum distance consistent with formation of an interference pattern (IP) thereon, and the procedure of firing a single photon or particle at Screen (SC′) described above, performed.

FIGS. 6a shows a double slit systems with first (SC) and second (SC′) screens, and FIG. 6b shows a double slit systems with first (SC), second (SC′) and third (SC″) screens. In use a reference interference pattern can be formed on a FIG. 6a first screen (SC) and a single photon or particle directed to second screen (SC′), (or vice versa); and in FIG. 6b reference interference patterns can be formed on first (SC) and third (SC″) screens, and a single photon or particle directed to second screen (SC′). Of course, it is necessary to remove a screen that would block a photon or particle. For instance, to form a reference interference pattern on the first screen (SC) in FIG. 6a requires the second screen (SC′) not be present during the formation process, as described in the Disclosure of the Invention Section of this Specification. As regards FIG. 6b, it is noted that a reference interference pattern formed on the first screen (SC) required second (SC′) and third (SC″) screens not be present during their formation process. Application of the present invention methodology requires securing the patterns which are formed at the various screen locations, not that said physical screens remain present during acquisition of data at the location of another screen.

It is proposed that chaos effects in slits (SL1) (SL2), (which chaos effects provide that minute changes in initial conditions can have drastic effects on results), might influence individual photon and particle trajectories.

It is noted that the Interference Patterns can be considered as “Renormalization Curves” in that they serve as way to give insight via a measurement to something that otherwise is not determinable.

Finally, it is noted that the Interference Pattern (IP) is actually situated in the plane of the First Screen (SC) and the Drawings show Intensity Curves. Squaring the Amplitudes thereof results in a typical Probability Pattern, which appears even more pronounced. For instance, in the case where intensities were 4 and 5, the probability based on the squares is 25/(25+16) is 61%, rather than 55%. Further, the Drawings are not to scale. An actual Double Slit System would have the Screens (SC (SC′) positioned further from the Slits (SL1) (SL2). An experimental approach might then allow better than a 50/50 determination of the probability as to which slit a photon or particle passes in a double slit system.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

I claim:

1. A method of applying a double slit system to the end of securing improved knowledge of both an interference pattern, and through which silt thereof a particle or photon passes in the act of forming said interference pattern, comprising the steps of:
a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
said system being arranged to allow said source to project a particle or photon at said barrier having two slits therein, pass through a slit and contribute to formation of an interference pattern at the first screen;
b) with only the first screen in place at a distance (X) from the double slits, causing a multiplicity of particles or photons from said source thereof to pass through one or the other of the slits in said barrier having two slits therein, and develop an interference pattern at the location of the first screen, and securing said pattern;
c) causing said second screen to be located at a distance (Y) from said barrier having two slits therein, wherein (Y) is less than (X);
d) causing a particle or photon to pass through one or the other of said slits in said-barrier having two slits therein, and impinge on said second screen;
e) noting the location where upon said second screen said particle in step d impinges, and projecting lines from each slit through said location on said second screen and determining where said lines impinge on the fixed the interference pattern developed in step b; and
concluding that the projection line consistent with the greatest probability corresponding to said interference pattern on the first screen indicates through which slit the particle or photon passed to a better than 50/50 certainty.

2. A method as in claim 1, in which the distance (X) at which the first screen is located is selected by determining the minimum distance from said double slits consistent with formation of an interference pattern, then moving it a distance dx further away and practicing step b; and wherein the distance (Y) at which the second screen is placed is said minimum distance from said double slits consistent with formation of an interference pattern before practicing steps c-e.

3. A method as in claim 1, causing a multiplicity of photons or particles to impinge on said second screen, while, one by one, repeating steps c-e, to the end that an interference pattern is achieved upon said second screen and improved knowledge of which slit the photon of particle passed.

4. A method as in claim 1, in which the source of particles or photons provides a selection from the group consisting of:
photons;
electrons;
positrons;
protons;
neutrons;
atoms
ionized atoms; and
molecules.

5. A method of applying a double slit system to the end of securing improved knowledge of both an interference pattern, and through which silt thereof a particle or photon passes in the act of forming said interference pattern, comprising the steps of:
a) providing a double slit system comprising:
a source of particles or photons capable of providing a single particle or photon at a time;
a barrier having two slits therein;
a second screen located at some distance (Y) from said barrier having two slits therein;
a first screen which can be located at a distance (X) from said barrier having two slits therein, wherein (X) is greater than (Y);
said system being arranged to allow said source to project a particle or photon at said barrier having two slits therein, pass through a slit and contribute to formation of an interference pattern at the first screen;
b) with the second screen in place at a distance (Y) from the double slits, causing a multiplicity of particles or photons from said source thereof to pass through one or the other of the slits in said barrier having two slits therein, and develop an interference pattern at the location of the second screen, and securing said pattern;
c) removing said second screen from said position (Y), and causing said first screen to be located at a distance (X) from said barrier having two slits therein, wherein (X) is greater than (Y);
d) causing a particle or photon to pass through one or the other of said slits in said barrier having two slits therein, and impinge on said first screen;
e) noting the location where upon said first screen said particle in step d impinges, and projecting lines from each slit to or through said location on said first screen and determining where said lines impinge on the fixed the interference pattern developed in step b; and
concluding that the projection line consistent with the greatest probability corresponding to the interference pattern on the second screen indicates through which slit the particle or photon passed to a better than 50/50 certainty.

6. A method as in claim 5, in which the distance (Y) at which the second screen is located is selected by determining the minimum distance from said double slits consistent with formation of an interference pattern and practicing step b; and wherein the first screen distance (X) is positioned dx further from the double slits than is the location (Y) of the second screen, before practicing steps c-e.

7. A method as in claim 5, causing a multiplicity of photons or particles to impinge on said second screen, while, one by one, repeating steps c-e, to the end that an interference pattern is achieved upon said forst screen and improved knowledge of which slit the photon of particle passed.

8. A method as in claim 5, in which the source of particles or photons provides a selection from the group consisting of:
photons;
electrons;
positrons;
protons;
neutrons;
atoms
ionized atoms; and
molecules.

9. A method as in claim 1, wherein steps b, d and e are controlled by a computer.

10. A method as in claim 5, wherein steps b, d and e are controlled by a computer.

11. A method of applying a double slit system to the end of securing improved knowledge of both an interference pattern, and through which silt thereof a particle or photon passes in the act of forming said interference pattern, comprising the steps of:
a) providing a double slit system comprising:
a source of particles or photons capable of providing a single particle or photon at a time;
a barrier having two slits therein;
a first screen located at some distance (X) from said barrier having two slits therein;
a second screen which can be located at a distance (Y) from said barrier having two slits therein, wherein (Y) is less than (X);
a third screen located at a distance (X′) from said barrier having two slits therein, wherein (X′) is less than (Y);
said system being arranged to allow said source to project a particle or photon at said barrier having two slits therein, pass through a slit and contribute to formation of an interference pattern at the first screen;
b1) with only the first screen in place at a distance (X) from the double slits, causing a multiplicity of particles or photons from said source thereof to pass through one or the other of the slits in said barrier having two slits therein, and develop an interference pattern at the location of the first screen, and securing said pattern;
b2) with only the third screen in place at a distance (X′) from the double slits, causing a multiplicity of particles or photons from said source thereof to pass through one or the other of the slits in said barrier having two slits therein, and develop an interference pattern at the location of the third screen, and securing said pattern;
c) removing said third screen and causing said second screen to be located at a distance (Y) from said barrier having two slits therein, wherein (Y) is less than (X) but greater than (X′);
d) causing a particle or photon to pass through one or the other of said slits in said barrier having two slits therein, and impinge on said second screen;
e) noting the location where upon said second screen said particle in step d impinges, and projecting lines from each slit through said location on said second and third screens and determining where said lines impinge on the fixed the interference pattern developed in steps b1 and b2; and
concluding that the projection line consistent with the greatest probability corresponding to said interference pattern on the first and third screen indicates through which slit the particle or photon passed to a better than 50/50 certainty.

12. A method as in claim 11, in which the distance (X′) at which the third screen is located is selected by determining the minimum distance from said double slits consistent with formation of an interference pattern when practicing step b2; and the distance (X) at which the first screen is a distance 2dx from said third screen location when practicing step b1, and the distance (Y) is inbetween said first and third screen locations, a distance dx from each thereof, when practicing steps c-e.

13. A method as in claim 11, causing a multiplicity of photons or particles to impinge on said second screen, while, one by one, repeating steps c-e, to the end that an interference pattern is achieved upon said second screen and improved knowledge of which slit the photon of particle passed.

14. A method as in claim 11, in which the source of particles or photons provides a selection from the group consisting of:
photons;
electrons;
positrons;
protons;
neutrons;
atoms
ionized atoms; and
molecules.

15. A method as in claim 11, wherein steps b1, b2, d and e are controlled by a computer.
